(19) United States
(12) Patent Application Publication
(10) Pub. No.: US 2026/0271028 A1
(43) Pub. Date: Sep. 10, 2026

(54) TERMINAL DEVICE AND METHOD FOR SIDELINK COMMUNICATIONS

(71) Applicant: LENOVO (BEIJING) LIMITED, Beijing (CN)

(72) Inventors: Zhennian SUN, Beijing (CN); Haipeng LEI, Beijing (CN); Xiaodong YU, Beijing (CN); Xin GUO, Beijing (CN)

(21) Appl. No.: 19/166,196

(22) PCT Filed: Mar. 28, 2023
(86) PCT No.: PCT/CN2023/084462

§ 371 Date: Sep. 17, 2025

(51) Int. Cl. H04W 72/25; H04W 72/02; H04W 72/044; H04W 72/563

(52) U.S. Cl. CPC H04W 72/25; H04W 72/02; H04W 72/046; H04W 72/563

(57) ABSTRACT

Embodiments of the present disclosure relate to a solution for sidelink communications. In one aspect, a terminal device determines a first set of physical sidelink feedback channels (PSFCHs) to be transmitted on a transmission occasion. The terminal device determines a transmission beam at least based on priorities associated with the first set of PSFCHs. Moreover, the terminal device selects, from the first set of PSFCHs, a second set of PSFCHs at least based on the priorities associated with the first set of PSFCHs. Then, the terminal device transmits the second set of PSFCHs on the transmission occasion with the determined transmission beam. In this way, it is possible to improve the flexibility of determination of the transmission beam and the selection of the second set of PSFCHs to be transmitted and thus improve transmission efficiency.

### FIELD

Embodiments of the present disclosure generally relate to the field of communication, and in particular to a terminal device, a method, and a non-transitory computer readable medium for sidelink communications.

### BACKGROUND

In telecommunications networks, such as long term evolution (LTE) networks or new radio (NR) networks, sidelink communications between user equipment (UEs) over a proximity services (ProSe) Communication 5 (PC5) wireless interface may be supported. In sidelink communications, UEs may communicate with each other directly via a PC5 wireless interface on a sidelink channel. Further, sidelink communications may obtain a plurality of benefits, such as coverage extension, service reliability enhancement, and potential low latency.

As discussed in the third generation partnership project (3GPP) release 16 (Rel-16), hybrid automatic repeat request (HARQ) feedback on a Physical Sidelink Feedback Channel (PSFCH) was introduced to achieve the high reliability of NR sidelink unicast and groupcast communications. Moreover, in the 3GPP release 17 (Rel-17), a PSFCH for conflict information (i.e. conflict indication) was introduced for inter-UE coordination. One UE may transmit the conflict information in the PSFCH to inform the reserved resource conflict. However, there are still some open problems, for example, for the transmissions on the PSFCHs in sidelink communications that will be studied in the near future.

### SUMMARY

In general, embodiments of the present disclosure provide a solution for resource selection in sidelink communications.

In a first aspect, there is provided a terminal device. The terminal device comprises a processor and a transceiver coupled to the processor. The processor is configured to determine a first set of physical sidelink feedback channels (PSFCHs) to be transmitted on a transmission occasion; determine a transmission beam at least based on priorities associated with the first set of PSFCHs; select, from the first set of PSFCHs, a second set of PSFCHs at least based on the priorities associated with the first set of PSFCHs; and transmit, via the transceiver, the second set of PSFCHs on the transmission occasion with the determined transmission beam.

In a second aspect, there is provided a method performed by a terminal device. The method comprises determining a first set of physical sidelink feedback channels (PSFCHs) to be transmitted on a transmission occasion; determining a transmission beam at least based on priorities associated with the first set of PSFCHs; selecting, from the first set of PSFCHs, a second set of PSFCHs at least based on the priorities associated with the first set of PSFCHs; and transmitting the second set of PSFCHs on the transmission occasion with the determined transmission beam.

In a third aspect, there is provided a non-transitory computer readable medium. The non-transitory computer readable medium having program instructions stored thereon. The program instructions, when executed by an apparatus, causing the apparatus at least to: determine a first set of physical sidelink feedback channels (PSFCHs) to be transmitted on a transmission occasion; determine a transmission beam at least based on priorities associated with the first set of PSFCHs; select, from the first set of PSFCHs, a second set of PSFCHs at least based on the priorities associated with the first set of PSFCHs; and transmit the second set of PSFCHs on the transmission occasion with the determined transmission beam.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2 illustrates a flowchart of an example method for communication in accordance with some embodiments of the present disclosure;

FIG. 3 illustrates a schematic diagram of an example transmission with a determined transmission beam in accordance with some embodiments of the present disclosure; and

FIG. 4 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, long term evolution (LTE), LTE-advanced (LTE-A), wideband code division multiple access (WCDMA), high-speed packet access (HSPA), narrow band internet of things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example, a resource in the time domain, a resource in the frequency domain, a resource in the space domain, a resource in code domain, or any other resource enabling a communication, and the like, used for performing a communication between a terminal device and a network device or between terminal devices. In the following, a resource in both frequency and time domains will be used as an example of a transmission resource for describing some embodiments of the present disclosure. It is noted that embodiments of the present disclosure equally apply to other resources in other domains.

As used herein, the term “sidelink transmission” generally refers to any transmission performed from one terminal device to another terminal device. The sidelink transmission may be used for transmitting any data or control information associated with sidelink communications, for example, sidelink data, sidelink control information, sidelink feedback information, or the like. As used herein, the term “sidelink channel” may generally refer to any channel used for sidelink communications, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

The communication in a sidelink system is different from the communication on the Uu interface, as the sidelink system is a distributed system. In the sidelink system, one UE may communicate to multiple sidelink UEs at the same time. As mentioned above, in Rel-16, sidelink HARQ feedback was introduced to achieve the high reliability of NR sidelink unicast and groupcast communication. The period of PSFCH resource in the time domain is configured per resource pool, e.g., 1/2/4 slots within the resource pool, and the minimum gap between a PSSCH/PSCCH transmission and a PSFCH reception is also configured with 2 or 3 slots. One sidelink UE may receive multiple PSSCHs and the PSFCHs associated with the received multiple PSSCHs may need to be transmitted in the same PSFCH occasion.

In addition, in Rel-16, the following PSFCH resource configuration/determination has been specified.

SL-PSFCH-Config-r16 ::= SEQUENCE {

| | | |
|---|---|---|
| sl-PSFCH-Period-r16 | ENUMERATED {sl0, sl1, sl2, sl4} | OPTIONAL, -- |

Need M

| | | |
|---|---|---|
| sl-PSFCH-RB-Set-r16 | BIT STRING (SIZE (10..275)) | OPTIONAL, -- |

Need M

| | | |
|---|---|---|
| sl-NumMuxCS-Pair-r16 | ENUMERATED {n1, n2, n3, n6} | OPTIONAL, -- |

Need M

| | | |
|---|---|---|
| sl-MinTimeGapPSFCH-r16 | ENUMERATED {sl2, sl3} | OPTIONAL, -- Need |

M

| | | |
|---|---|---|
| sl-PSFCH-HopID-r16 | INTEGER (0..1023) | OPTIONAL, -- Need |

M
sl-PSFCH-CandidateResourceType-r16 ENUMERATED {startSubCH, allocSubCH}
OPTIONAL, -- Need M
...
}

There were also some discussions on PSFCH reception/transmission.

| | |
|---|---|
| 16.2.4.2 | Simultaneous PSFCH transmission/reception |

For a PSFCH transmission or reception with HARQ-ACK information, a priority value for the
PSFCH is equal to the priority value indicated by an SCI format 1-A associated with the PSFCH.
For PSFCH transmission with conflict information, a priority value for the PSFCH is equal to the
smallest priority value determined by the corresponding SCI format(s) 1-A for the conflicting
resource(s).
For PSFCH reception with conflict information, a priority value for the PSFCH is equal to the
priority value determined by the corresponding SCI format 1-A for the conflicting resource.
If a UE

| | |
|---|---|
| - | would transmit N_{sch, Tx, PSFCH} PSFCHs and receive N_{sch, Rx, PSFCH} PSFCHs, and |
| - | transmissions of the N_{sch, Tx, PSFCH} PSFCHs would overlap in time with receptions of the |
| | N_{sch, Rx, PSFCH} PSFCHs |

the UE transmits or receives only a set of PSFCHs corresponding to the smallest priority field
value, as determined by a first set of SCI format 1-A and/or a second set of SCI format 1-A [5, TS
38.212] that are respectively associated with PSFCHs with HARQ-ACK information from the
N_{sch, Tx, PSFCH} PSFCHs and PSFCHs with HARQ-ACK information from the N_{sch, Rx, PSFCH}
PSFCHs when one or more of the PSFCHs provide HARQ-ACK information. If none of the
N_{sch, Tx, PSFCH} PSFCHs and none of the N_{sch, Rx, PSFCH} PSFCHs provide HARQ-ACK
information, the UE transmits or receives only a set of PSFCHs corresponding to the smallest
priority value of the first set of PSFCHs and the second set of PSFCHs that are respectively
associated with the N_{sch, Tx, PSFCH} PSFCHs and the N_{sch, Rx, PSFCH} PSFCHs when the PSFCHs
provide conflict information.
If a UE would transmit N_{sch, Tx, PSFCH} PSFCHs in a PSFCH transmission occasion, the UE first
transmits PSFCHs with HARQ-ACK information from N_{Tx, PSFCH} PSFCHs corresponding to the
smallest priority field values from the N_{Tx, PSFCH} priority field values, if any. Subsequently, the
UE transmits remaining PSFCHs with conflict information corresponding to the smallest
remaining priority field values from the N_{Tx, PSFCH} priority field values, if any.
If a UE indicates a capability to receive N_{Rx, PSFCH} PSFCHs in a PSFCH reception occasion [18,
TS 38.306], the UE first receives PSFCHs with HARQ-ACK information, if any, and
subsequently receives PSFCHs with conflict information, if any.

In Rel-16 where HARQ feedback on the PSFCH is supported, there is also a limitation of the number of simultaneous PSFCH transmissions due to the UE capability. If the total number of PSFCHs the UE can transmit is larger than the maximum number of simultaneous PSFCH transmissions, the UE only selects a subset of PSFCHs according to the associated priority of the PSFCH.

Beside the PSFCH for HARQ feedback, inter-UE coordination scheme 2 was also introduced in Rel-17 sidelink enhancement. With the inter-UE coordination scheme 2, one UE may transmit a resource conflict indicator on the PSFCH to other UEs if it detects the resource conflict of the reserved resources from other UEs. The PSFCH resources for the resource conflict indicator are FDMed with the PSFCH resources for sidelink HARQ feedback. As an example, when the UE transmits the PSFCH for HARQ feedback and the PSFCH for resource conflict indicator in one PSFCH occasion, the UE may firstly transmit the PSFCH for HARQ feedback and then transmits the PSFCH for conflict information.

Moreover, the sidelink operation on frequency range 2 (FR2) licensed spectrum has been approved in the work item description (WID) of Release 18 (Rel-18) sidelink evolution with the following objective:

| 1. | Study and specify enhanced sidelink operation on FR2 licensed spectrum [RAN1, RAN2, | |
|---|---|---|
| | RAN4] (This part of the work is put on hold until further checking in RAN#97) | |
| | - | Update evaluation methodology for commercial deployment scenario |
| | - | Work is limited to the support of sidelink beam management (including initial |
| | | beam-pairing, beam maintenance, and beam failure recovery, etc) by reusing existing |
| | | sidelink CSI framework and reusing Uu beam management concepts wherever possible. |

| | |
|---|---|
| ∘ | Beam management in FR2 licensed spectrum considers sidelink unicast |
| | communication only. |

In this WID, the PSFCH for beam management (such as the PSFCH for initial beam pairing, the PSFCH for beam maintenance, and the PSFCH for beam failure recovery) has been also introduced.

Moreover, for the sidelink operation on FR2, both analog beamforming and digital beamforming may be supported for Rel-18 sidelink evolution. If one UE only supports analog beamforming, and it must transmit multiple PSFCHs in one PSFCH occasion, how to transmit or select the PSFCHs should be addressed if the transmission beams of the PSFCHs are different.

Further, as discussed above, in Rel-18 sidelink operation on FR2, there may be multiple types of PSFCHs (such as the PSFCH for HARQ feedback, the PSFCH for conflict information, or the PSFCH for beam management) to be transmitted/received in one PSFCH occasion. In this case, the issue on multiple PSFCH transmissions considering different transmission beams and different types of PSFCHs is also needed to be addressed.

In view of the above, as of now, there is no effective way to allow transmissions of multiple types of PSFCHs in one PSFCH occasion for the UE supporting only analog beamforming, when different transmission beams need to be applied for different PSFCHs. Therefore, there is a need for an improved solution for the PSFCH transmissions in such a case.

In view of the above discussions, embodiments of the present disclosure provide a solution for resource selection in sidelink communications. In one aspect of the solution of the present disclosure, a terminal device determines a first set of physical sidelink feedback channels (PSFCHs) to be transmitted on a transmission occasion. The terminal device determines a transmission beam at least based on priorities associated with the first set of PSFCHs. Moreover, the terminal device selects, from the first set of PSFCHs, a second set of PSFCHs at least based on the priorities associated with the first set of PSFCHs. Then, the terminal device transmits the second set of PSFCHs on the transmission occasion with the determined transmission beam.

By considering priority information associated with the PSFCHs, this solution allows to determine an appropriate transmission beam. Then, based on the priority information associated with the PSFCHs, a subset of PSFCHs to be transmitted (i.e. the second set of PSFCHs) using the determined appropriate beam can be selected from the first set of PSFCHs. In this way, it is possible to improve the flexibility of determination of the transmission beam and the selection of the subset of PSFCHs to be transmitted and thus improve transmission efficiency.

Principles and implementations of embodiments of the present disclosure will be described in detail below with reference to the figures.

### Example Environment

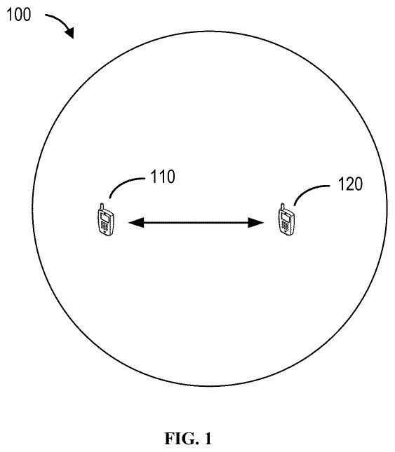

Reference is first made to FIG. 1, which illustrates a schematic diagram of a communication environment 100 in which some embodiments of the present disclosure can be implemented. As shown in FIG. 1, the communication environment 100, which may be a part of a communication network, comprises terminal devices 110 and 120.

As an example, the terminal devices 110 and 120 may perform a sidelink transmission, which is also referred to as a device-to-device (D2D) communication. Just for the purpose of discussion, in some example embodiments, the terminal device 120 will be taken as an example of a transmitting (TX) device that initiates a sidelink transmission. The terminal device 110 will be taken as an example of a receiving (RX) device of the sidelink transmission. In this case, the terminal device 110 may transmit HARQ feedback for the sidelink transmission on the PSFCH to the terminal device 120. Alternatively or additionally, the terminal device 110 may transmit other types of PSFCHs (for example, the PSFCH for conflict information and the PSFCH for beam management) to the terminal device 120. As another example, the terminal devices 110 and/or 120 may communicate with one or more further terminal devices not shown in FIG. 1.

Although the terminal devices 110 and 120 are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the terminal devices 110 and 120 are schematically depicted as mobile phones in FIG. 1, it is understood that these depictions are exemplary in nature without suggesting any limitation. In other embodiments, the terminal devices 110 and 120 may be any other communication devices, for example, any other wireless communication devices.

It is to be understood that the particular number of various communication devices and the particular number of various communication links as shown in FIG. 1 is for illustration purpose only without suggesting any limitations. The communication environment 100 may include any suitable number of communication devices and any suitable number of communication links for implementing embodiments of the present disclosure. In addition, it should be appreciated that there may be various wireless as well as wireline communications (if needed) among all of the communication devices.

The communications in the communication environment 100 may follow any suitable communication standards or protocols, which are already in existence or to be developed in the future, such as universal mobile telecommunications system (UMTS), long term evolution (LTE), LTE-advanced (LTE-A), the fifth generation (5G) new radio (NR), wireless fidelity (Wi-Fi) and worldwide interoperability for microwave access (WiMAX) standards, and employs any suitable communication technologies, including, for example, multiple-input multiple-output (MIMO), orthogonal frequency division multiplexing (OFDM), time division multiplexing (TDM), frequency division multiplexing (FDM), code division multiplexing (CDM), bluetooth, ZigBee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

### Example Method

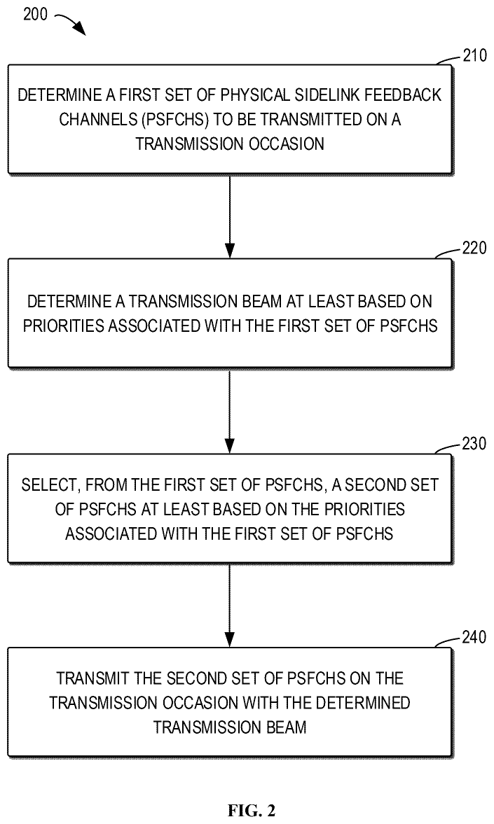

FIG. 2 illustrates a flowchart of an example method 200 for communication in accordance with some embodiments of the present disclosure. In some embodiments, the method 200 can be implemented at a device in a communication network, such as the terminal device 110 as shown in FIG. 1. Additionally or alternatively, the method 200 can be implemented at other devices (for example, the terminal device 120) shown in FIG. 1. In some other embodiments, the method 200 may be implemented at devices not shown in FIG. 1. Further, it is to be understood that the method 200 may include additional blocks not shown and/or may omit some blocks as shown, and the scope of the present disclosure is not limited in this regard. For the purpose of discussion, the method 200 will be described from the perspective of the terminal device 110 with reference to FIG. 1.

As shown in FIG. 2, at block 210, the terminal device 110 determines a first set of physical sidelink feedback channels (PSFCHs) to be transmitted on a transmission occasion. In some examples, the first set of PSFCHs may comprise a plurality of types of PSFCH. For example, the first set of PSFCHs may comprise a PSFCH for beam management, or in other words, a PSFCH used to transmit information related to beam management. The beam management may comprise initial beam-pairing, beam maintenance, beam failure recovery, etc. As another example, the first set of PSFCHs may comprise a PSFCH for HARQ feedback, or in other words, a PSFCH used to transmit information related to sidelink HARQ feedback. As a further example, the first set of PSFCHs may comprise a PSFCH for a conflict indication informing a reserved conflict, or in other words, a PSFCH used to transmit information related to conflict indication. Alternatively or additionally, the first set of PSFCHs may comprise any combination of the above-mentioned types of PSFCHs.

For each PSFCH, it may have one transmission beam determined during a beam management procedure, e.g., the transmission beam of one PSFCH may be the reception beam corresponding to the PSSCH/PSCCH. If multiple PSFCHs are needed to be transmitted in one PSFCH occasion, the terminal device 110 may need to determine an actual transmission beam for the transmissions of PSFCHs. Thus, as shown in FIG. 2, at block 220, the terminal device 110 determines a transmission beam at least based on priorities associated with the first set of PSFCHs.

In some examples, the priority associated with the PSFCH for beam management may be determined in a variety of approaches. As an example, the priority associated with the PSFCH for beam management may be configured, pre-configured, or predefined, for example, in the specification. The priority associated with the PSFCH for beam management may be fixed with the highest priority or configured with a value from “0” to “7”. As another example, the priority associated with the PSFCH for beam management may be indicated in sidelink control information (SCI) associated with the PSFCH. In this case, if the PSFCH for beam management is associated with one SCI, the associated priority of the PSFCH may be the same as the indicated priority in the SCI. Alternatively or additionally, the priority associated with the PSFCH for beam management may be a highest priority among one or more priorities of one or more sidelink unicast transmissions, in the case that the PSFCH is used for beam failure recovery. In this case, for the PSFCH for beam failure recovery, the associated priority of the PSFCH may be the highest priority among the priorities of ongoing sidelink transmissions associated with this sidelink unicast link.

For example, the priority associated with the PSFCH for HARQ feedback may be determined as the priority of a sidelink transmission associated with the PSFCH. As an example, the priority associated with the PSFCH for a conflict indication may be determined as a higher priority associated with a terminal device in the detected conflicts.

Based on the above approaches, the priorities associated with the first set of PSFCHs may be determined. Then, on this basis, the terminal device 110 may determine the transmission beam. The following paragraphs will describe how to determine the transmission beam at least based on the priorities associated with the first set of PSFCHs.

Regarding the determination of the transmission beam, some prioritization criteria may be made considering different information carried by the PSFCHs. In some embodiments, the first set of PSFCHs may be categorized as at least one of a first category and a second category. The first category may be prioritized over the second category.

As an example, the terminal device 110 may first determine whether the first category is null. If not, and if there is one PSFCH in the first category associated with a highest priority among priorities associated with PSFCHs in the first category, the terminal device 110 may determine the transmission beam as a transmission beam of the PSFCH with the highest priority in the first category. If there is more than one PSFCH in the first category associated with a same highest priority among the priorities associated with PSFCHs in the first category, the terminal device 110 may determine the transmission beam as a transmission beam by which a largest number of PSFCHs among the more than one PSFCH in the first category are covered.

Then, if the first category is null, that is, if there is no PSFCH in the first category, and if there is one PSFCH in the second category associated with a highest priority among priorities associated with PSFCHs in the second category, the terminal device 110 may determine the transmission beam as a transmission beam of the PSFCH with the highest priority in the second category. If there is no PSFCH in the first category, and there is more than one PSFCH in the second category associated with a same highest priority among the priorities associated with PSFCHs in the second category, the terminal device 110 may determine the transmission beam as a transmission beam by which a largest number of PSFCHs among the more than one PSFCH in the second category are covered.

For example, the first category may be associated with at least one of a PSFCH for beam management or a PSFCH for HARQ feedback, and the second category may be associated with a PSFCH for a conflict indication. In other words, in this case, the PSFCH for beam management and the PSFCH for HARQ feedback may be assumed to have the same prioritization order, and they are prioritized over the PSFCH for the conflict indication. In this example, the details for the category division and the transmission beam determination may be performed as follows:
Category 1: PSFCHs for beam management and PSFCHs for HARQ feedback
Category 2: PSFCHs for the conflict indication

In this case, the terminal device 110 may determine the actual transmission beam with the following steps:
If Category 1 is not NULL
   The terminal device 110 may determine the actual transmission beam same as the transmission beam of a PSFCH with the highest associated priority from the PSFCHs within Category 1, or
   If there is more than one PSFCH within Category 1 associated with the highest priority, the terminal device 110 may determine the actual transmission beam based on the largest number of PSFCHs covered by the transmission beam.
Else
   The terminal device 110 may determine the actual transmission beam same as the transmission beam of a PSFCH with the highest associated priority from the PSFCHs within Category 2, or
   If there is more than one PSFCH within Category 2 associated with the highest priority, the terminal device 110 may determine the actual transmission beam based on the largest number of PSFCHs covered by the transmission beam.

In some embodiments, the category of the first set of PSFCHs may further comprise a third category. In this case, the first set of PSFCHs may be categorized as at least one of the first category, the second category, and a third category. The first category, and the second category may be prioritized over the third category.

In this case, besides the above determination steps for the transmission beam as discussed for the case where the category of the first set of PSFCHs comprises the first category and the second category, the transmission beam determination may further involve the following steps. If the terminal device 110 determines that there is no PSFCH in the first category or the second category, and there is one PSFCH in the third category associated with a highest priority among priorities associated with PSFCHs in the third category, the terminal device 110 may determine the transmission beam as a transmission beam of the PSFCH with the highest priority in the third category. If there is no PSFCH in the first category or the second category, and there is more than one PSFCH in the third category associated with a same highest priority among the priorities associated with PSFCHs in the third category, the terminal device 110 may determine the transmission beam as a transmission beam by which a largest number of PSFCHs among the more than one PSFCH in the third category are covered.

As an example, the first category may be associated with a PSFCH for beam management, the second category may be associated with a PSFCH for HARQ feedback, and the third category may be associated with a PSFCH for a conflict indication. In other words, in this case, the PSFCH for beam management may be prioritized to the PSFCH for HARQ feedback, and the PSFCH for HARQ feedback may be prioritized to the PSFCH for the conflict information. In this example, the details for the category division and the transmission beam determination may be performed as follows:
Category 1: PSFCHs for beam management
Category 2: PSFCHs for HARQ feedback
Category 3: PSFCHs for the conflict indication

In this case, the terminal device 110 may determine the actual transmission beam with the following steps:
If Category 1 is not NULL
   The terminal device 110 may determine the actual transmission beam same as the transmission beam of a PSFCH with the highest associated priority from the PSFCHs within Category 1, or
   If there is more than one PSFCH within Category 1 associated with the highest priority, the terminal device 110 may determine the actual transmission beam based on the largest number of PSFCHs covered by the transmission beam.
Else if Category 2 is not NULL
   The terminal device 110 may determine the actual transmission beam same as the transmission beam of a PSFCH with the highest associated priority from the PSFCHs within Category 2, or
   If there is more than one PSFCH within Category 2 associated with the highest priority, the terminal device 110 may determine the actual transmission beam based on the largest number of PSFCHs covered by the transmission beam
Else
   The terminal device 110 may determine the actual transmission beam same as the transmission beam of a PSFCH with the highest associated priority from the PSFCHs within Category 3, or
   If there is more than one PSFCH within Category 3 associated with the highest priority, the terminal device 110 may determine the actual transmission beam based on the largest number of PSFCHs covered by the transmission beam

As another example, the first category may be associated with a PSFCH for HARQ feedback, the second category may be associated with a PSFCH for beam management, and the third category may be associated with a PSFCH for a conflict indication. In other words, in this case, the PSFCH for HARQ feedback may be prioritized to the PSFCH for beam management, and the PSFCH for beam management may be prioritized to the PSFCH for the conflict indication. In this example, the details for the category division and the transmission beam determination may be performed as follows:
Category 1: PSFCHs for HARQ feedback
Category 2: PSFCHs for beam management
Category 3: PSFCHs for the conflict indication

In this case, the terminal device 110 may determine the actual transmission beam with the following steps:
If Category 1 is not NULL
   The terminal device 110 may determine the actual transmission beam same as the transmission beam of a PSFCH with the highest associated priority from the PSFCHs within Category 1, or
   If there is more than one PSFCH within Category 1 associated with the highest priority, the terminal device 110 may determine the actual transmission beam based on the largest number of PSFCHs covered by the transmission beam.
Else if Category 2 is not NULL
   The terminal device 110 may determine the actual transmission beam same as the transmission beam of a PSFCH with the highest associated priority from the PSFCHs within Category 2, or
   If there is more than one PSFCH within Category 2 associated with the highest priority, the terminal device 110 may determine the actual transmission beam based on the largest number of PSFCHs covered by the transmission beam
Else
   The terminal device 110 may determine the actual transmission beam same as the transmission beam of a PSFCH with the highest associated priority from the PSFCHs within Category 3, or
   If there is more than one PSFCH within Category 3 associated with the highest priority, the terminal device 110 may determine the actual transmission beam based on the largest number of PSFCHs covered by the transmission beam

With the above approaches, the transmission beam may be determined, however, for example, due to the terminal device capability of simultaneous PSFCH transmissions, the terminal device 110 may need to select a subset of PSFCHs from all PSFCHs with the restriction of terminal device capability (for example, assuming N_{max,PSFCH} is the maximum number of PSFCHs that the terminal device 110 may be capable to perform PSFCH transmissions at the same time). The terminal device 110 may need to further determine which PSFCHs to be transmitted with the determined actual transmission beam. Thus, as shown in FIG. 2, at block 230, the terminal device 110 selects, from the first set of PSFCHs, a second set of PSFCHs at least based on the priorities associated with the first set of PSFCHs.

In some embodiments, the terminal device 110 may select the second set of PSFCHs according to the prioritization order associated with different categories as discussed above, and within each category of PSFCHs, the selection of the PSFCH may be from the highest priority to the lowest priority with a further check that the transmission beam of the selected PSFCH is the same as the determined transmission beam.

For example, after determining the actual transmission beam of PSFCH, the terminal device 110 may select N (1≤N≤N_{max,PSFCH}) PSFCHs (that is, the second set of PSFCH comprises N PSFCHs) from the first set of PSFCHs according to the prioritization order associated with different categories as discussed above, and within each category of PSFCHs, the selection of the PSFCH may be from the highest priority to the lowest priority, and the terminal device 110 may further check whether the transmission beam of the PSFCH to be selected is the same as the determined transmission beam.

In the embodiments where the first set of PSFCHs is categorized as the first category and the second category, the second set of PSFCHs may be firstly selected from the first category, and then from the second category, with a descending order of a priority associated with each PSFCH per each of the first category and the second category, while checking that a transmission beam of a selected PSFCH is the same as the determined transmission beam. As an example, in the cases where the first category is associated with at least one of a PSFCH for beam management or a PSFCH for HARQ feedback, and the second category is associated with a PSFCH for a conflict indication, N PSFCH transmissions may be firstly selected from the PSFCHs for beam management and PSFCHs for HARQ feedback, and then from the PSFCHs for the conflict indication, and the selection of the PSFCH within each category of PSFCHs may be with the descending order of associated priority of each PSFCH, and the transmission beam of the selected PSFCH may be the same as the determined transmission beam.

In the embodiments where the first set of PSFCHs is categorized as the first category, the second category, and the third category, the second set of PSFCHs may be firstly selected from the first category, then from the second category, and lastly from the third category, with a descending order of a priority associated with each PSFCH per each of the first category, the second category and the third category, while checking that a transmission beam of a selected PSFCH is the same as the determined transmission beam.

As an example, in the cases where the first category is associated with a PSFCH for beam management, the second category is associated with a PSFCH for HARQ feedback, and the third category is associated with a PSFCH for a conflict indication, N PSFCH transmissions may be firstly selected from the PSFCHs for beam management and then from the PSFCHs for HARQ feedback, and lastly from the PSFCHs for the conflict indication, and the selection of the PSFCH within each category of PSFCHs may be with the descending order of associated priority of each PSFCH, and the transmission beam of the selected PSFCH may be the same as the determined transmission beam.

As another example, in the cases where the first category may be associated with a PSFCH for HARQ feedback, the second category may be associated with a PSFCH for beam management, and the third category may be associated with a PSFCH for a conflict indication, N PSFCH transmissions may be firstly selected from the PSFCHs for HARQ feedback and then from the PSFCHs for beam management, and lastly from the PSFCHs for the conflict indication, and the selection of the PSFCH within each category of PSFCHs may be with the descending order of associated priority of each PSFCH, and the transmission beam of the selected PSFCH may be the same as the determined transmission beam.

In some embodiments, the terminal device 110 may select the second set of PSFCHs according to the prioritization order associated with different categories as discussed above, and within each category of PSFCHs, the selection of the PSFCH may be from the highest priority to the lowest priority, and the terminal device 110 may further determine whether a PSFCH may be selected based on estimated degradation of antenna gain between its own transmission beam of this PSFCH and the determined transmission beam if they are different. In this case, for example, if the estimated degradation of antenna gain is smaller than a threshold, the PSFCH may be selected even if its transmission beam of the PSFCH and the determined transmission beam are different. In this, it is considered that such performance degradation is acceptable. As an example, the threshold may be configured, pre-configured, or predefined, for example, in the specification, and for example, in the unit of dB.

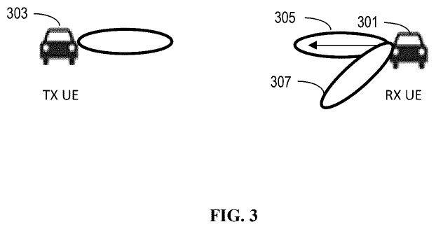

Reference is made to FIG. 3 to describe the above case in detail, which illustrates a schematic diagram of an example transmission with a determined transmission beam in accordance with some embodiments of the present disclosure. In this case, the first terminal device 110 is implemented by an RX UE 301, and the second terminal device 120 is implemented by a TX UE 303. As shown in FIG. 3, the TX UE 303 may transmit a PSSCH/PSCCH to the RX UE 301, and the RX UE 301 may transmit a PSFCH to the TX UE 303. The ideal case may be that RX UE 301 uses the transmission beam 305 which is the same as the reception beam of the PSSCH/PSCCH to transmit the PSFCH, in which case, no performance degradation will occur. However, due to the multiple PSFCH transmissions, the RX UE 301 may use a further beam 307 (i.e. the determined transmission beam) to transmit the PSFCH, in this case, there is a need to determine whether to perform the PSFCH transmission with a determined transmission beam different from the ideal transmission beam as used in the ideal case.

The linkloss of the PSSCH/PSCCH transmission from TX UE 303 to RX UE 301 may be AntennaGain_{TX_(TX UE)}+Pathloss+AntennaGain_{RX_(RX UE)}, and the linkloss of the PSFCH transmission from the RX UE 301 to the TX UE 303 may be AntennaGain_{TX_(RX UE)}+Pathloss+AntennaGain_{RX_(TX UE)}. Comparing the calculation of two linkloss, the pathloss of the two paths may be assumed to be the same, and the AntennaGain_{TX_(TX UE)}=AntennaGain_{RX_(TX UE)} since the TX UE 303 may use the reception beam the same as the transmission beam of the PSSCH/PSCCH to receive the PSFCH. Thus, it can be seen that the main difference of the two linkloss is that the difference between AntennaGain_{RX_(RX UE)} and AntennaGain_{TX_(RX UE)}. For example, the antenna gain calculation may be based on an assumption that the TX UE 305 is located in the main lobe of the transmission beam of the PSFCH, for example, in the direction indicated with the arrow in FIG. 3.

In view of the above, in this case, there may be no need to limit that the transmission beam of a PSFCH is always the same as the determined transmission beam, to avoid dropping of some PSFCHs with higher priority if their transmission beams are not the same as the determined transmission beam. In other words, both the priority and the degradation of the antenna gain may be considered, if the transmission beam of the PSFCH is different from the determined transmission beam.

In some embodiments, the terminal device 110 may select the second set of PSFCHs according to the prioritization order associated with different categories as discussed above, and within each category of PSFCHs, the selection of the PSFCH may be from the highest priority to the lowest priority with a further check that whether the transmission beam of a PSFCH to be selected is same as the determined transmission beam or whether the degradation of the antenna gain between the transmission beam of a PSFCH to be selected and the determined transmission beam is smaller than a threshold, if the transmission beam of the PSFCH to be selected and the determined transmission beam are different.

For example, after determining the actual transmission beam of PSFCH, the terminal device 110 may select N (1≤N≤N_{max,PSFCH}) PSFCHs from the first set of PSFCHs according to the prioritization order associated with different categories as discussed above, and within each category of PSFCHs, the selection of the PSFCH may be from the highest priority to the lowest priority, and the terminal device 110 may check whether the transmission beam of a PSFCH to be selected is the same as the determined transmission beam or whether the degradation of the antenna gain between the transmission beam of a PSFCH to be selected and the determined transmission beam is smaller than a threshold, if the transmission beam of the PSFCH to be selected and the determined transmission beam are different.

In the embodiments where the first set of PSFCHs is categorized as the first category and the second category, the second set of PSFCHs may be firstly selected from the first category, and then from the second category, with a descending order of a priority associated with each PSFCH per each of the first category and the second category, while checking that a transmission beam of a selected PSFCH is the same as the determined transmission beam or a degradation of antenna gain between the transmission beam of the selected PSFCH and the determined transmission beam is smaller than a threshold. As an example, in the cases where the first category is associated with at least one of a PSFCH for beam management or a PSFCH for HARQ feedback, and the second category is associated with a PSFCH for a conflict indication, N PSFCH transmissions may be firstly selected from the PSFCHs for beam management and PSFCHs for sidelink HARQ feedback, and then from the PSFCHs for conflict information, and the selection of the PSFCH within each category of PSFCHs may be with the descending order of associated priority of each PSFCH and the transmission beam of the selected PSFCH may be the same as the determined transmission beam or the degradation the antenna gain between the transmission beam of the selected PSFCH and determined transmission beam is smaller than a threshold if the transmission beam of the selected PSFCH and determined transmission beam are different.

In the embodiments where the first set of PSFCHs is categorized as the first category, the second category, and the third category, the second set of PSFCHs may be firstly selected from the first category, then from the second category, and lastly from the third category, with a descending order of a priority associated with each PSFCH per each of the first category, the second category and the third category, while checking that a transmission beam of a selected PSFCH is the same as the determined transmission beam or a degradation of antenna gain between the transmission beam of the selected PSFCH and the determined transmission beam is smaller than a threshold.

As an example, in the cases where the first category is associated with a PSFCH for beam management, the second category is associated with a PSFCH for HARQ feedback, and the third category is associated with a PSFCH for a conflict indication, N PSFCH transmissions may be firstly selected from the PSFCHs for beam management and then from the PSFCHs for HARQ feedback, and lastly from the PSFCHs for conflict information, and the selection of the PSFCH within each category of PSFCHs may be with the descending order of associated priority of each PSFCH, and the transmission beam of the selected PSFCH may be the same as the determined transmission beam or the degradation the antenna gain between the transmission beam of the selected PSFCH and determined transmission beam is smaller than a threshold if the transmission beam of the selected PSFCH and determined transmission beam are different.

As another example, in the cases where the first category may be associated with a PSFCH for HARQ feedback, the second category may be associated with a PSFCH for beam management, and the third category may be associated with a PSFCH for a conflict indication, N PSFCH transmissions may be firstly selected from the PSFCHs for HARQ feedback and then from the PSFCHs for beam management, and lastly from the PSFCHs for conflict information, and the selection of the PSFCH within each category of PSFCHs may be with the descending order of associated priority of each PSFCH, and the transmission beam of the selected PSFCH may be the same as the determined transmission beam or the degradation the antenna gain between the transmission beam of the selected PSFCH and determined transmission beam is smaller than a threshold if the transmission beam of the selected PSFCH and determined transmission beam are different.

Referring back to FIG. 2, after determining the second set of PSFCHs, at block 240, the terminal device 110 transmits the second set of PSFCHs on the transmission occasion with the determined transmission beam.

By considering priority information associated with the PSFCHs, it is allowed to determine an appropriate transmission beam. Then, based on the priority information associated with the PSFCHs, the second set of PSFCH to be transmitted using the determined appropriate beam can be selected from the first set of PSFCHs. In this way, it is possible to improve the flexibility of determination of the transmission beam and the selection of the second set of PSFCHs to be transmitted and thus improve transmission efficiency.

### Example Device

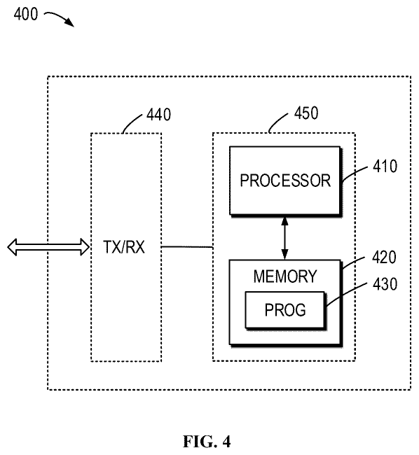

FIG. 4 illustrates a simplified block diagram of a device 400 (also termed as an apparatus 1100) that is suitable for implementing embodiments of the present disclosure. The device 400 can be considered as a further example implementation of the terminal devices 110 and 120 as shown in FIG. 1. Accordingly, the device 400 can be implemented at or as at least a part of the terminal devices 110 and 120.

As shown, the device 400 includes a processor 410, a memory 420 coupled to the processor 410, a suitable transmitter (TX) and receiver (RX) 440 coupled to the processor 410, and a communication interface coupled to the TX/RX 440. The memory 410 stores at least a part of a program 430. The TX/RX 440 is for bidirectional communications. The TX/RX 440 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), Uu interface for communication between the eNB or gNB and a terminal device, or PC5 interface for communication between two terminal devices.

The program 430 is assumed to include program instructions that, when executed by the associated processor 410, enable the device 400 to operate in accordance with the embodiments of the present disclosure, as discussed herein with reference to FIGS. 1A to 3. The embodiments herein may be implemented by computer software executable by the processor 410 of the device 400, or by hardware, or by a combination of software and hardware. The processor 410 may be configured to implement various embodiments of the present disclosure. Furthermore, a combination of the processor 410 and memory 420 may form processing means 450 adapted to implement various embodiments of the present disclosure.

The memory 420 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 420 is shown in the device 400, there may be several physically distinct memory modules in the device 400. The processor 410 may be of any type suitable to the local technical network, and may include one or more of general purpose computers, special purpose computers, microprocessors, digital signal processors (DSPs) and processors based on multicore processor architecture, as non-limiting examples. The device 400 may have multiple processors, such as an application specific integrated circuit chip that is slaved in time to a clock which synchronizes the main processor.

In some embodiments, an apparatus capable of performing the method 200 (for example, the terminal device 110) may comprise means for performing the respective steps of the method 200. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 200.

In some embodiments, the apparatus comprises: means for determining a first set of physical sidelink feedback channels (PSFCHs) to be transmitted on a transmission occasion; means for determining a transmission beam at least based on priorities associated with the first set of PSFCHs; means for selecting, from the first set of PSFCHs, a second set of PSFCHs at least based on the priorities associated with the first set of PSFCHs; and means for transmitting the second set of PSFCHs on the transmission occasion with the determined transmission beam.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
a processor; and
a transceiver coupled to the processor,
wherein the processor is configured to:
determine a first set of physical sidelink feedback channels (PSFCHs) to be transmitted on a transmission occasion;
determine a transmission beam at least based on priorities associated with the first set of PSFCHs;
select, from the first set of PSFCHs, a second set of PSFCHs at least based on the priorities associated with the first set of PSFCHs; and
transmit, via the transceiver, the second set of PSFCHs on the transmission occasion with the determined transmission beam.

2. The terminal device of claim 1, wherein the first set of PSFCHs comprises one of the following:
a PSFCH for beam management;
a PSFCH for hybrid automatic repeat request (HARQ) feedback; or
a PSFCH for a conflict indication informing a reserved conflict.

3. The terminal device of claim 2, wherein the first set of PSFCHs comprises a PSFCH for beam management, and a priority associated with the PSFCH for beam management is one of the following:
configured, pre-configured, or predefined; or
indicated in sidelink control information (SCI) associated with the PSFCH; or
a highest priority among one or more priorities of one or more sidelink unicast transmissions, in the case that the PSFCH is used for beam failure recovery.

4. The terminal device of claim 1, wherein the first set of PSFCHs is categorized as at least one of a first category and a second category, the first category is prioritized over the second category, and determining the transmission beam comprises:
based on determining that there is one PSFCH in the first category associated with a highest priority among priorities associated with PSFCHs in the first category, determining the transmission beam as a transmission beam of the PSFCH with the highest priority in the first category; or
based on determining that there is more than one PSFCH in the first category associated with a same highest priority among the priorities associated with PSFCHs in the first category, determining the transmission beam as a transmission beam by which a largest number of PSFCHs among the more than one PSFCH in the first category are covered; or
based on determining that there is no PSFCH in the first category, and there is one PSFCH in the second category associated with a highest priority among priorities associated with PSFCHs in the second category, determining the transmission beam as a transmission beam of the PSFCH with the highest priority in the second category; or
based on determining that there is no PSFCH in the first category, and there is more than one PSFCH in the second category associated with a same highest priority among the priorities associated with PSFCHs in the second category, determining the transmission beam as a transmission beam by which a largest number of PSFCHs among the more than one PSFCH in the second category are covered.

5. The terminal device of claim 4, wherein:
the first category is associated with one of a PSFCH for beam management or a PSFCH for HARQ feedback; or
the second category is associated with a PSFCH for a conflict indication.

6. The terminal device of claim 4, wherein the second set of PSFCHs is firstly selected from the first category, and then from the second category, with a descending order of a priority associated with each PSFCH per each of the first category and the second category, and wherein one of the following:
a transmission beam of a selected PSFCH is the same as the determined transmission beam; or
a degradation of antenna gain between the transmission beam of the selected PSFCH and the determined transmission beam is smaller than a threshold.

7. The terminal device of claim 4, wherein the first set of PSFCHs is categorized as at least one of the first category, the second category, or a third category, the first category and the second category are prioritized over the third category, and determining the transmission beam further comprises:
based on determining that there is no PSFCH in the first category or the second category, and there is one PSFCH in the third category associated with a highest priority among priorities associated with PSFCHs in the third category, determining the transmission beam as a transmission beam of the PSFCH with the highest priority in the third category; or
based on determining that there is no PSFCH in the first category or the second category, and there is more than one PSFCH in the third category associated with a same highest priority among the priorities associated with PSFCHs in the third category, determining the transmission beam as a transmission beam by which a largest number of PSFCHs among the more than one PSFCH in the third category are covered.

8. The terminal device of claim 7, wherein:
the first category is associated with a PSFCH for beam management;
the second category is associated with a PSFCH for HARQ feedback; or
the third category is associated with a PSFCH for a conflict indication.

9. The terminal device of claim 7, wherein:
the first category is associated with a PSFCH for HARQ feedback;
the second category is associated with a PSFCH for beam management; or
the third category is associated with a PSFCH for a conflict indication.

10. The terminal device of claim 7, wherein the second set of PSFCHs is firstly selected from the first category, then from the second category, and lastly from the third category, with a descending order of a priority associated with each PSFCH per each of the first category, the second category and the third category, and wherein one of the following:
a transmission beam of a selected PSFCH is the same as the determined transmission beam; or
a degradation of antenna gain between the transmission beam of the selected PSFCH and the determined transmission beam is smaller than a threshold.

11. The terminal device of claim 6 or 10, wherein the threshold is configured, pre-configured, or predefined.

12. A method performed by a terminal device, comprising:
determining a first set of physical sidelink feedback channels (PSFCHs) to be transmitted on a transmission occasion;
determining a transmission beam at least based on priorities associated with the first set of PSFCHs;
selecting, from the first set of PSFCHs, a second set of PSFCHs at least based on the priorities associated with the first set of PSFCHs; and
transmitting the second set of PSFCHs on the transmission occasion with the determined transmission beam.

13. A non-transitory computer readable medium having program instructions stored thereon that, when executed by an apparatus, cause the apparatus at least to:
determine a first set of physical sidelink feedback channels (PSFCHs) to be transmitted on a transmission occasion;
determine a transmission beam at least based on priorities associated with the first set of PSFCHs;
select, from the first set of PSFCHs, a second set of PSFCHs at least based on the priorities associated with the first set of PSFCHs; and
transmit the second set of PSFCHs on the transmission occasion with the determined transmission beam.
